(19) United States
(12) Patent Application Publication
(10) Pub. No.: US 2019/0090246 A1
(43) Pub. Date: Mar. 21, 2019

(54) SYSTEM AND METHOD FOR GRANTING AVAILABLE NETWORK CAPACITY TO MOBILE DEVICES

(71) Applicant: TUBE Incorporated, Chelmsford, MA (US)

(72) Inventors: Shantigram Jagannath, Chelmsford, MA (US); Lokendra Singh Chauhan, Bengaluru (IN); Sharmistha Chatterjee, Karnataka (IN); Minyan Shi, Chelmsford, MA (US); Robin Balyan, Chelmsford, MA (US)

(73) Assignee: TUBE Incorporated, Chelmsford, MA (US)

(21) Appl. No.: 16/136,517

(22) Filed: Sep. 20, 2018

Related U.S. Application Data
(60) Provisional application No. 62/561,446, filed on Sep. 21, 2017.

(51) Int. Cl. H04W 72/04; H04W 28/18; H04W 24/02; H04W 24/08; H04W 64/00; H04W 28/02; H04W 28/08

(52) U.S. Cl. CPC H04W 72/0486; H04W 28/18; H04W 24/02; H04W 28/08; H04W 64/003; H04W 28/0284; H04W 24/08

(57) ABSTRACT

Disclosed herein is a system and method for granting available network capacity to mobile devices. The system locates a mobile device's cell based on its location and classifies the cell, and its associated carriers and sectors, based on different properties like busy level, bandwidth, and RF data in real time at different times of the day. Varying types of network cells with under-utilized capacity are identified using a cloud-based system to provide an online trigger to nearby mobile users to utilize the network capacity for any kind of data usage. Models are used to infer device RF conditions and details of network cellular parameters under consideration to dynamically improve the service in a heterogeneous crowd-sourced environment.

### CROSS-REFERENCE TO RELATED APPLICATIONS

This application claims priority to provisional application 62/561,446, filed on Sep. 21, 2017, which is herein incorporated by reference in its entirety.

### TECHNICAL FIELD

The present invention relates generally to systems and methods for granting network capacity to mobile devices and more particularly to a type of measurement, analysis, and data-driven method in communication systems and networks.

### BACKGROUND OF THE INVENTION

The unprecedented growth of mobile networks has resulted in issues in distributing a limited wireless spectrum fairly among users during periods of high demand. During peak hours, popular internet services (like streaming and cloud-based services) continue to get used at the highest level, increasing network congestion. Moreover, it has not been possible to infer radio frequency (RF) conditions or cell loads from all mobile devices most of the time at different times of the day.

Network congestion is becoming an ever-increasing problem. Operators have attempted a variety of strategies to match the network demand capacity with existing infrastructure, as the cost of deploying additional network capacities is expensive. To keep the cost under control, operators apply control measures to attempt to allocate bandwidth fairly among users and throttle the bandwidth of users that consume excessive bandwidth. This approach has had limited success. Alternatively, techniques that utilize extra bandwidth for quality of experience (QOE) efficiency by over-provisioning the network has proved to be ineffective and inefficient due to lack of proper estimation.

Thus, there is a need for improved techniques for early detection of network congestion and methods of effectively utilizing spare network capacity in a demand-centric environment in an attractive and cost-friendly manner.

### SUMMARY OF THE INVENTION

According to various embodiments, a system for granting available network capacity to one or more mobile devices in a cellular operator network is disclosed. The system includes an EUTRAN cell identifier (ECI) locator module configured to determine the ECI the mobile device is connected to at a given location. The system further includes an online classification module configured to classify one or more cells within cellular networks. The system also includes a network capacity estimator module configured to estimate individual cell capacity within the cellular operator network and predict available network capacity for the ECI to which the mobile device is connected. The system further includes a network capacity grant module configured to grant available network capacity based on the predicted available network capacity. The system additionally includes an analytics module configured to analyze predicted network capacity compared to actual network availability and provide feedback to the online classification module and network capacity estimator module.

According to various embodiments, a method for granting available network capacity to one or more mobile devices in a cellular operator network is disclosed. The method includes determining an ECI the mobile device is connected to at a given location, classifying one or more cells within cellular networks, estimating individual cell capacity for the cellular operator network and predicting available network capacity for the ECI to which the mobile device is connected, granting available network capacity based on the predicted available network capacity, and analyzing predicted network capacity compared to actual network availability and providing feedback.

Various other features and advantages will be made apparent from the following detailed description and the drawings.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only exemplary embodiments of the invention and are not, therefore, to be considered to be limiting its scope, the invention will be described and explained with additional specificity and detail through the use of the accompanying drawings, in which:

FIG. 1A is a block diagram of the overall system components showing means of granting excess network capacity to end-users through a mobile application according to an embodiment of the present invention;

FIG. 1B is a block diagram of the cloud-based system components involved in ECI identification, algorithm training, prediction, and generation of analytics according to an embodiment of the present invention;

FIG. 2 is a graphical diagram of the overall operation of an EUTRAN cell identifier (ECI) locator module according to an embodiment of the present invention;

FIG. 3A is a flow chart of operation of an ECI locator module to locate neighboring sectors and carriers according to an embodiment of the present invention;

FIG. 3B is a flow chart for predicting serving sectors and carriers' capacity for an IOS device according to an embodiment of the present invention;

FIG. 4 is a block diagram of an ECI locator module that updates and auto-corrects neighbor lists based on the frequency of radio data reported from devices according to an embodiment of the present invention;

FIG. 5A is a block diagram of new cell detection detected by incoming network data or removal of a cell tower by a network operator according to an embodiment of the present invention;

FIG. 5B is a block diagram of a cellular module to update each cell's capacity prediction timeline according to an embodiment of the present invention;

FIG. 5C is a block diagram of a receiving session request to compute session availability in the most probable ECI according to an embodiment of the present invention;

FIG. 5D is a block diagram of online cell classification and training along with built-in feedback techniques to incorporate error for prediction improvement according to an embodiment of the present invention;

FIG. 6 is a block diagram of a network capacity module with pre-processing, classification, training, and prediction according to an embodiment of the present invention;

FIG. 7A is a graph of cell capacity usage prediction according to an embodiment of the present invention;

FIG. 7B is another graph of cell capacity usage prediction according to an embodiment of the present invention;

FIG. 7C is yet another graph of cell capacity usage prediction according to an embodiment of the present invention;

FIG. 8 is a block diagram of session availability analytics according to an embodiment of the present invention; and

FIG. 9 is a chart of the co-relation between different classified cellular groups based on capacity usage, downlink resource block utilization, and incremental data physical resource block (PRB) utilization (IDPU) according to an embodiment of the present invention.

### DETAILED DESCRIPTION OF THE INVENTION

Disclosed herein is a system deployed in a cellular operator network for granting available network capacity to mobile devices. The system includes an evolved universal terrestrial radio access network (EUTRAN) cell identifier/identity (ECI) locator module (ELM), an online classification module, an online training module, a network capacity estimator module, a network capacity grant module, and an analytics module.

The ECI may determine a cell coverage radius in terms of geometric areas (such as a circle or other shape) and its home sector based on a current location of the mobile device (latitude & longitude), device radio data if present, cell tower configuration (azimuth and beam width), and radio frequency propagation models for urban, sub-urban, and rural areas out of all sectors covering the given mobile device location.

The ELM may split a geographical region covered by the cellular network into a rectangle grid, sub-dividing it further into smaller rectangular grids. The ELM may receive radio access network (RAN) information from all neighboring devices where radio information is available, such as crowdsourced RAN information via other mobile devices (e.g. Android devices). The crowdsourced RAN data is modelled dynamically using probabilistic weighted modelling to derive the mobile device's current home sector from a set of neighboring sectors. The crowdsourced RAN information model may be configured to infer the type of cell along with band and carrier. The RAN information model may take into consideration a band preference in ascending order of 2, 4, and 13 while returning a most probable sector where the device is located.

The ELM may update and auto-correct a neighbor list by removing old stale neighbors or adding new neighbors to its list based on frequency of radio data reported from other mobile devices, updated cell map data received from an operator, and the mobile device's location within a sector, between overlapping sectors, or outside a coverage region. The ELM may update an ECI database in case of the addition or removal of any cell towers at any given location or the updating of physical parameters of the ECI such as allocation of extra bandwidth or change in antennae direction. The ELM may be enhanced by using historic data of cell tower properties and radio frequency models so that a transition of sub-urban to urban regions is addressed by discovering the newly transited cell's wider coverage or higher signal strength.

The system may further comprise a network receiver and an aggregator module configured to receive past and current operator data from all cells across a cellular network at specified hours. The network receiver and aggregator module may be configured to receive and aggregate data received from different localities and operating business markets where cell towers are installed.

The online classification module may receive data from the network receiver module, extract cells from different localities, and compute statistics of cell characteristics and behavior for a given locality from a timestamp of last received data to a defined historic timestamp of the past. The online classification module may be configured to classify cellular networks based on location and region (including urban, sub-urban, and rural), bandwidth, sector, carrier, and antennae direction.

The online training module may include a learning algorithm that is trained based on cell characteristics and a threshold of training parameters being decided at run-time by analyzing previous predictions errors. The online classification module may be configured to define or change at runtime if needed and benchmark classified cellular networks based on historic data and most recently received data to learn recent trends of any selected cellular group. The online classification module may be configured to learn short term (hourly or daily) and long term (weekly or monthly) changes of any cell within any selected cellular group from device recorded radio parameters as well as historic network data.

The network capacity estimator module may use classification data to estimate individual cell capacity for the entire operator network at different future time instants. The network capacity estimator module may include memory sufficient to store predicted forecasts in the event that data has failed to arrive from the network operator. The network capacity estimator module may be configured to do weight based historic modelling in cases of missing network data for any hour, day, or week. The network capacity estimator module may determine a number of network sessions that can be granted to mobile users in any given ECI. The network capacity estimator module may determine a remaining number of network sessions that can be granted each time to new clients after granting successive sessions (1, 2, or 3) to different applications. The network capacity estimator module may determine a change in network throughput after a network session is granted to an application.

The network capacity estimator module may learn incremental changes in network capacity for different kinds of applications when sessions are granted of varying durations. The network capacity estimator module may estimate an efficiency of different cell types in the network based on resources needed for incremental usage by the user and may also learn incremental data physical-resource utilization (IDPU), which is the incremental physical resources required from the cellular network for every incremental unit of mobile data, for any given category of cell. An IDPU due to available session grants may be linked to the distance of the device from the cell tower as signal to noise ratio (SNR) decreases from high to mid to low values as the device moves away from the cell tower to the cell edge, having the highest signal strength near cell-tower, decreasing towards mid-cell, and cell-edge having the lowest signal-strength. The network capacity estimator module may consider an estimate of additional resources as used by every incremental session that is granted and increment an estimate of the network capacity for a cell before granting the next session request. This helps to account for every session that is granted and take into consideration the network overheads due to session grants, to minimize overall congestion on the network cell.

The disclosed invention addresses the challenges of effectively utilizing spare network capacity in demand centric environments in the following ways. The disclosed invention inferences cell types and cell radio frequency (RF) conditions based on crowdsourcing from a grid of cells. The grid of cells may be a country-wide rectangular grid of cells. The inferencing system may infer a home sector of a mobile device using device radio information when multiple carriers are collocated at the same cell tower.

The disclosed invention may detect under-utilized network capacity of an operator network with over one million cells in real time. The disclosed invention may also characterize cell-behavior in real-time on an hourly basis for different types of cells (rural, urban, and suburban) at different times of the day based on network data as well as aggregated crowdsourced data. The disclosed invention may devise, update, and use algorithms at run-time based on network cell classification.

The disclosed invention may determine and dynamically adjust busy thresholds for different cellular classification groups to define and benchmark conditions for granting excess network sessions. The disclosed invention may also devise built-in discovery mechanisms in mobile apps to discover available network capacity and use it judiciously based on available time duration. The disclosed invention may enable real time computations to determine short-term and long-term changes introduced in the network by allowing users to use additional network capacity. The disclosed invention may determine cell behavior in different types of cells before and after granting additional usage sessions.

The disclosed invention may introduce learning capacity change in the network by different kinds of applications when additional sessions are granted to any mobile user. The disclosed invention may discover strategies to notify users when excess capacity is available in the network cell. The disclosed invention may evaluate session cost to be paid by end-users when sessions are granted to users from different cell types from a network neighborhood of cells. The disclosed invention may enhance marketing means to help users use additional capacity by promoting discounts and/or rewards.

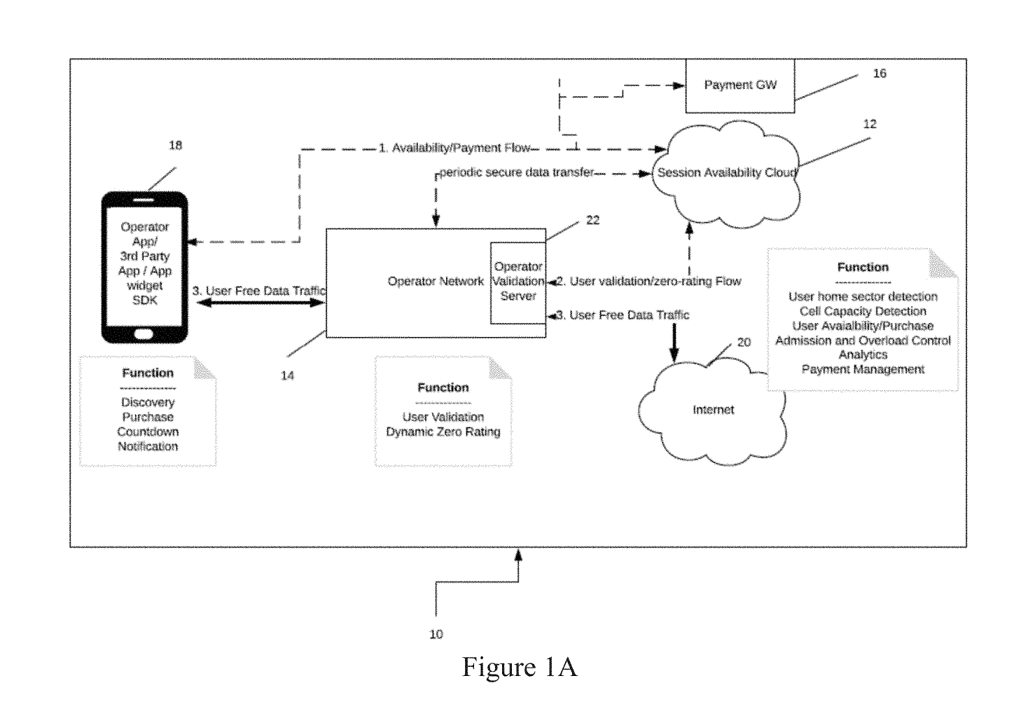

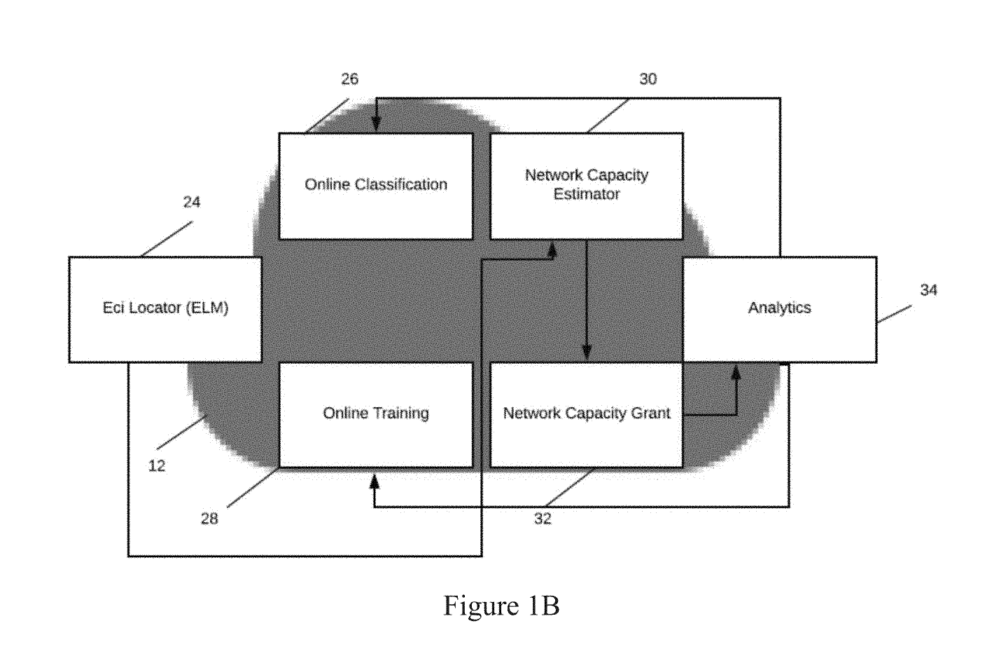

FIG. 1A is a block diagram showing the overall system components according to an embodiment of the present invention.

FIG. 1A shows a system 10 including a session availability cloud 12, an operator network 14, a payment gateway 16, a user device 18, and an internet 20.

The operator network 14 and internet 20 may be implemented as a single network or a combination of multiple networks. The operator network 14 and internet 20 may include but is not limited to wireless telecommunications networks, Zigbee, or other cellular communication networks involving 3G, 4G, 5G, and/or LTE.

The user device 18 may be implemented in a variety of configurations including general computing devices such as desktop computers, laptop computers, tablets, networks appliances, or mobile devices such as mobile phones, smart phones, or smart watches, as nonlimiting examples. The user device 18 includes one or more processors for performing specific functions and memory for storing those functions.

The session availability cloud 12 identifies the exact carrier, sector, and eNodeB of the core operator network 14 based on the location of the user device 18, and grants session of available duration based on network capacity in the same cell (carrier, sector and eNodeB) in real time.

The core operator network 14 receives requests from one or more mobile devices, such as user device 18, and inserts a mobile station international subscriber directory number (MSISDN). Further, the operator network 14 can zero-rate valid content dynamically from valid users. An operator validation server 22 within or separate from the operator network 14 performs user validation from its MSISDN and forwards valid requests to the session availability cloud 12.

The payment gateway 16 formulates a charging policy to the end-users of one or more user devices 18 based on available network capacity in a given locality within a given radius including all neighboring ECIs, sectors, and carriers and their associated band classes. The payment gateway 16 is thus capable of generating a dynamic cost for each session granted to any ECI within the same neighborhood at the same and/or different times of the day to the same and/or different band-class, sector, or carrier depending on any surrounding ECI's capacity and probability of network congestion in the immediate future, based on recent as well as historic data.

FIG. 1B is a block diagram showing cloud-based system components according to an embodiment of the present invention. The cloud-based system components may be included in the session availability cloud 12. This is a crowd-sourced system including an ECI locator module 24, an online classification module 26, an online training module 28, a network capacity estimator module 30, a network capacity grant module 32, and an analytics module 34 deployed in any cellular operator network, such as operator network 14.

The crowd-sourced cloud-based system acts as a server to mobile clients (users of the mobile device 18) for notifying them to use additional network capacity (if available) in real-time in the ECI where the mobile client is located. The crowd-sourced system is equipped to classify more than 1 million cells at run-time as per defined interval, based on cell bandwidth, sector, carrier as well as type of the cell-type (urban, sub-urban, or rural) and its usage in the past. The system may auto-learn new cells installed and/or removed from the cellular operator network 14 based on network data and incoming requests from users of the mobile device 18. The crowd-sourced system is provided a framework to auto-train newly classified cells as per defined periodic interval. The online training process undertakes random selection of varied types of cells with extreme minima, maxima and variance within each classified group. Each cell is updated with an algorithm in real-time based on its updated classification characteristics and newly trained data.

The ECI locator module 24 determines the ECI the user device 18 is connected to at a given location (latitude and longitude) based on crowd-sourced current and historic RAN information reported by other user devices in the surrounding locality. The ECI locator module 24 determines the coverage radius of the user device 18 in terms of geometric areas (such as a circle or other polygon) and its home sector based on its current location (latitude & longitude), device radio data if present, cell tower configuration (azimuth and beam-width), radio frequency propagation models for urban, sub-urban, and/or rural areas out of all sectors covering the given device location. The accuracy of ECI locator module 24 is enhanced by using historic data of cell tower properties and radio frequency models so that a transition from a sub-urban to urban region is addressed by discovering the newly transited cell's wider coverage or higher signal strength. Incoming RAN information is modelled dynamically using probabilistic weighted modelling to devise the current home sector of the user device 18 from a set of neighboring sectors and other devices present in those sectors. The ECI locator module 24 updates an ECI database in case of the addition and/or removal of any cell tower at any given location or the updating of physical parameters of the ECI like allocation of extra bandwidth or change in antennae direction.

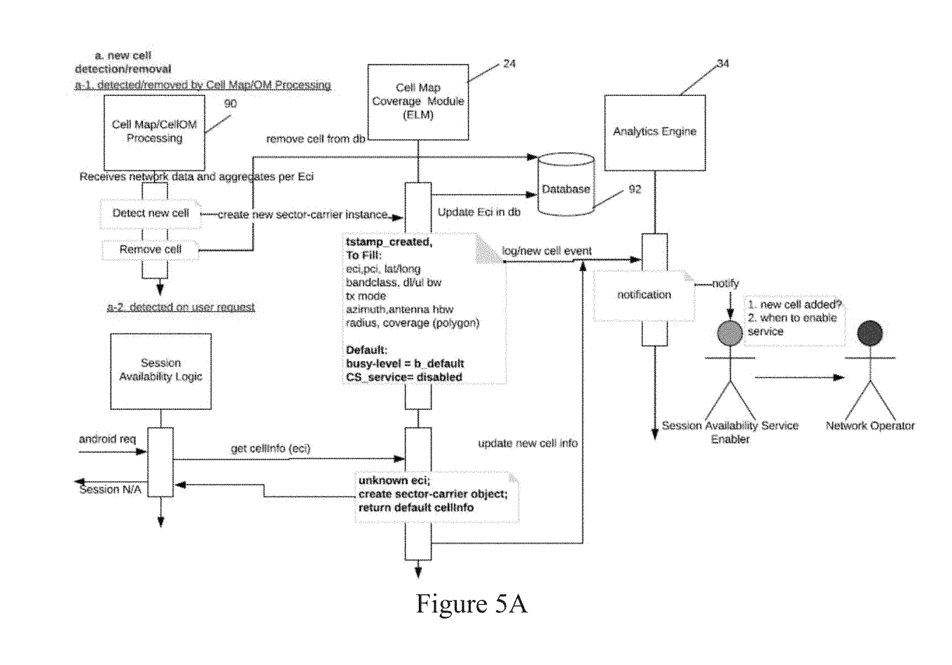

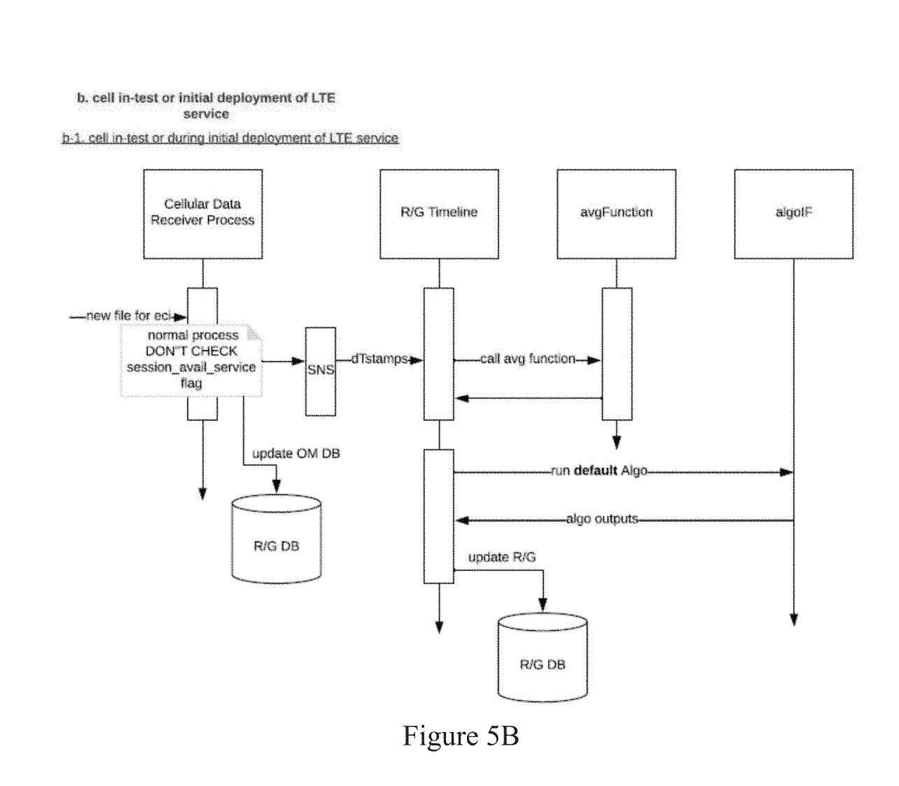

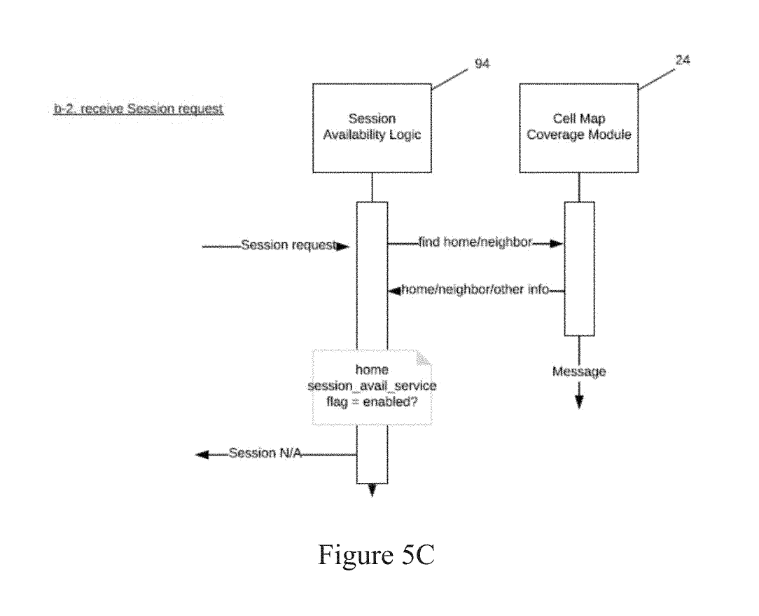

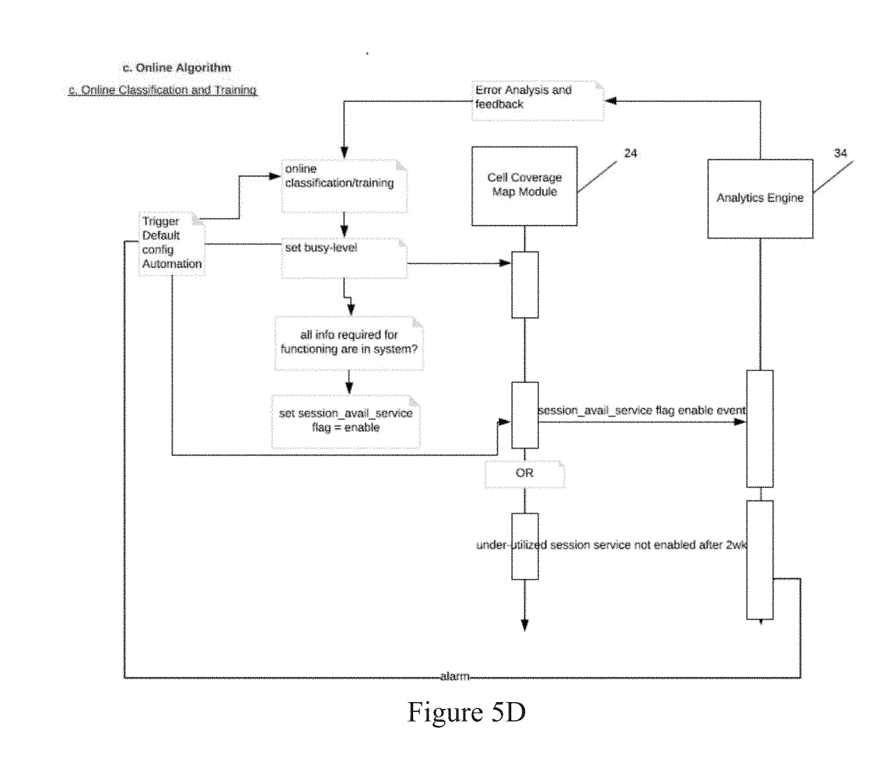

A network receiver and aggregator module (shown in FIG. 5A) receives past operator data from all cells across the cellular network daily at specified hours with a delay of few hours. The network receiver and aggregator module is configured to receive and aggregate data received from different localities and operating business markets where cell towers are installed.

The online classification module 26 receives data from a network receiver and aggregator module, extracts cells from different localities, and computes statistics of cell characteristics and behavior for a given locality from a timestamp of the latest received data to a defined history of the past. The online classification module 26 is configured to classify cellular networks based on location, region (urban, sub-urban, or rural), bandwidth, sector, carrier, and/or antennae direction.

The online training and learning module 28 gets trained based on cell characteristics, where the threshold of training parameters is decided at run-time by analyzing previous predictions errors. The online training module 28 is configured to define and benchmark classified cellular networks based on historic data and most recently received data to learn recent trends of any selected cellular group. The online training module 28 is further configured to learn short term (hourly or daily) and long term (weekly or monthly) changes of any cell within any selected cellular group from device recorded radio parameters as well as historic network data, e.g., a football game in a stadium.

The network capacity estimator module 30 receives recent hourly network data (resource block utilization and number of users) from internet service providers and device radio data from mobile devices. The network capacity estimator module 30 uses classification data to estimate individual cell capacity for the entire operator network 14 at current and different future time instants, ranging from current time to, e.g., 15 mins, 32 mins, 1 day, 1 week. The network capacity estimator module 30 then characterizes cells based on their behavior and predicts available network capacity for an ECI at present and in the nearest future. The network capacity estimator module 30 uses historic network data to determine and analyze trends in different cellular classification groups for an accurate forecast. The network capacity estimator module 30 has sufficient memory to store predicted forecasts in case data has failed to arrive from the network operator 14. The network capacity estimator module 30 is capable of weight based historic modelling in case of missing network data for any hour, day, or week for a single cell or multiple cells. The network capacity estimator module 30 determines the number of network sessions that can be granted to users of the user device 18 in any given ECI.

The network capacity grant module 32 grants available capacity in real-time per ECI to different mobile application users (users of one or more user device 18) in terms of network usage sessions with time units ranging from current time, 15 mins to 60 mins, as nonlimiting examples.

The network capacity estimator module 30 continually re-computes incremental overhead in the ECI due to granting of network sessions by the network capacity grant module 32, where the type of session is governed by the application type and how the session is being used. For example, a browsing session can consume few kilobytes of data whereas a streaming session can consume several megabytes of data. The network capacity estimator module 30 also computes overhead introduced by giving first, second, third network sessions to any cell and henceforth. It also considers the type of sector, carrier, and cell bandwidth during successive grants of network sessions in the same cell. The network capacity estimator module 30 continually learns and updates incremental capacity usage per application for different classified groups of cells.

The network capacity estimator module 30 determines a remaining number of network sessions that can be granted each time to new clients after granting successive sessions to different applications. The network capacity estimator module 30 determines a change in network throughput after a network session is granted to an application. The network capacity estimator module 30 learns incremental change in network capacity for different kinds of applications when sessions are granted of varying durations. The network capacity estimator module 30 learns incremental change in network capacity for any given category of cell.

The analytics module 34 analyzes the forecasted number of users, resource block utilization (such as physical resource block (PRB)) in each cell and compare it against network data received to determine predicted error. This predicted error information is learnt and fed to an algorithm estimator module to increase accuracy of future forecasts. The predicted error information is used by the analytics module 34 to readjust classification groups' behavioral parameters and training module's training dataset and parameters.

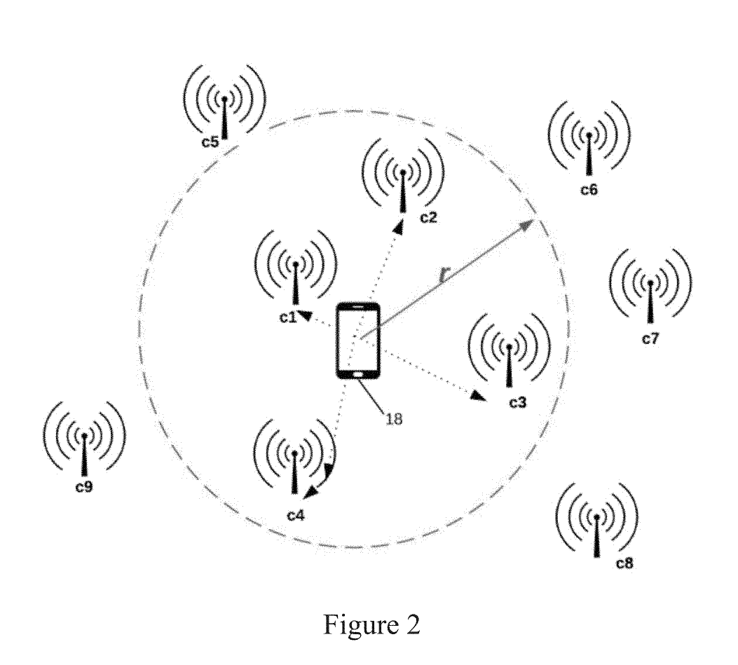

FIG. 2 is a diagram showing basic operation of the ECI locator module 24. As described above, the ECI locator module 24 is located within the session availability cloud 12 and determines the RF location of the user device 18 from a grid or circular layout as well as accurately finding the exact carrier, sector, and eNodeB where the user device 18 is in from a multitude of sectors surrounding the user device 18. The ECI locator module 24 is primarily responsible for splitting the geographically distributed cells of an operator based on location, coverage-area, and density of neighboring cells. RF data is recorded as reported by other user devices and the RF condition of a nearby user device is predicted based on probabilistic weighted modelling of RF data received through crowdsourcing. FIG. 2 illustrates neighboring cell towers (with antennas) situated within and outside a configured radius of a user device 18.

The ECI locator module 24 is further capable of predicting a newly discovered cell's type, band, and/or sector based on distance within the configured radius or grid. The ECI Locator module 24 can detect a device's presence in the middle of a sector, among two overlapping sectors, or outside of a coverage area. The ECI locator module 24 can be configured to run in a “normal mode” or “conservative mode” based on network conditions (e.g. support for carrier aggregation) to grant available sessions from higher capacity bands (2 and 4) or from all bands, respectively. The ECI locator module 24 is capable of finding sectors on all bands/sectors or just sectors on band class 2 and 4, or finding sectors of all band classes or just sectors on band class 2 and 4 of sectors and carriers nearest to the device with the highest downlink frequency among a set of co-located sectors and carriers, depending on its configured mode of operation as well the user device's presence inside or outside of a sector.

The ECI Locator module 24 is capable of detecting whether the user device 18 is in the home country of the operator or is in roaming state and accordingly return most likely carriers and sectors having the highest signal strength surrounding the device location.

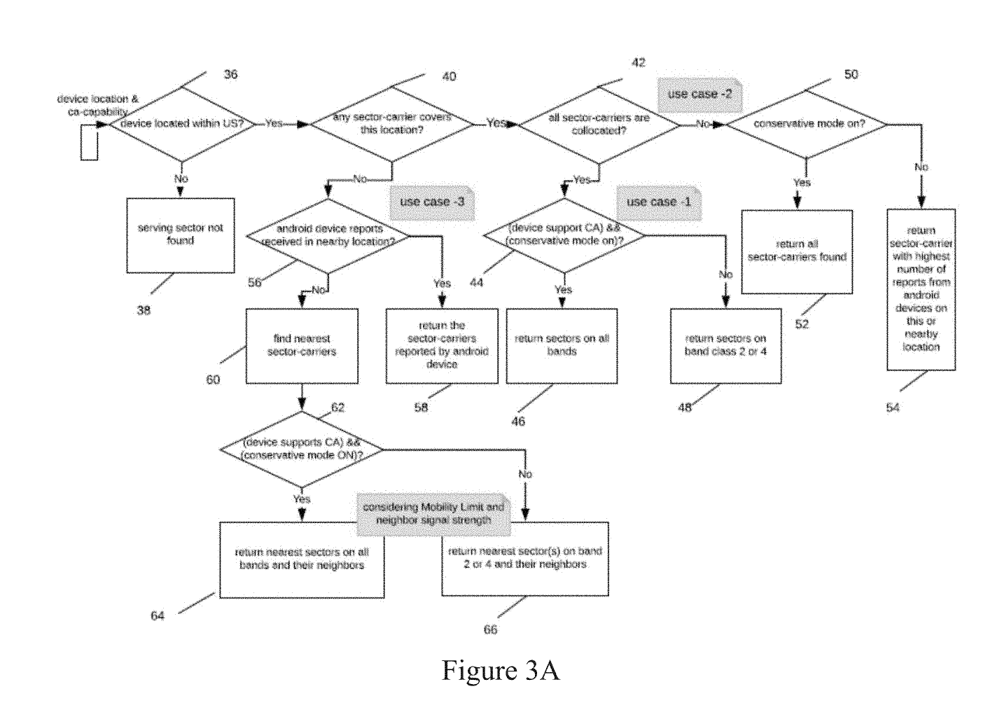

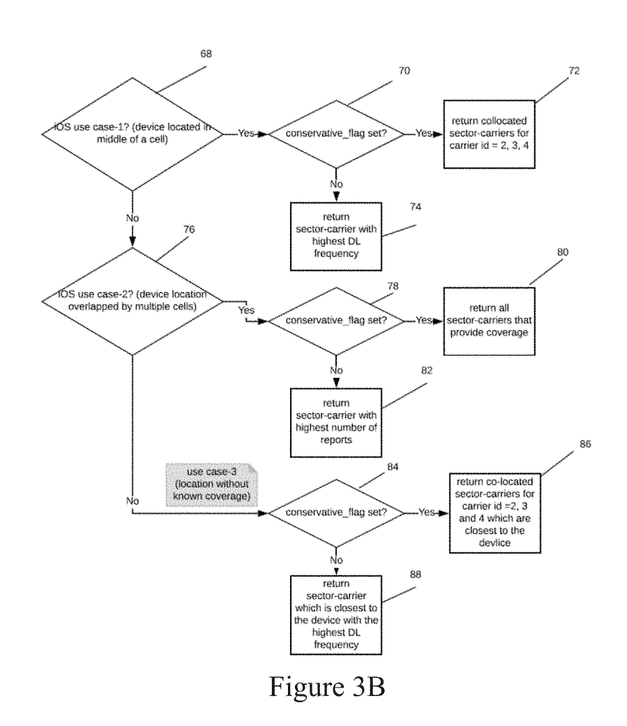

FIG. 3A is a flow chart showing operation of the ECI locator module 24 to locate neighboring sectors and carriers. FIG. 3A illustrates operation for an Android device, but similar operating systems to Android may use the same implementation as well.

The module starts at step 36, where the module 24 queries whether the user device 18 is located in the operator country. If no, the serving sector is not found at step 38. If yes, the module 24 then queries whether any sector-carriers cover the location of the user device 18 at step 40. If yes, the module 24 queries whether all sector-carriers are collocated at step 42.

If yes, the module 24 asks whether a “conservative mode” is on at step 44. If yes, the module 24 returns sectors on all bands at step 46. If no, the module 24 returns sectors on band classes 2 and 4 at step 48. This may be referred to as Case 1.

Returning back to step 42, if the answer is no, then the module 24 again queries whether “conservative mode” is on at step 50. If yes, the module 24 returns all sector-carriers found at step 52. If no, the module 24 returns the sector-carrier with the highest number of reports from user devices from current or nearby location at step 54. This may be referred to as Case 2

Returning further back to step 40, if the answer is no, then the module 24 queries whether user device reports were received in nearby locations at step 56. If yes, then the module 24 returns the sector-carriers reported by the user devices at step 58. If no, then the module 24 finds the nearest sector-carriers at step 60. The module 24 then queries whether “conservative mode” is on at step 62. If yes, the module 24 returns the nearest sectors on all bands and their neighbors at step 64, considering mobility limit and neighbor signal strength. If no, the module 24 returns the nearest sector(s) on bands 2 or 4 and their neighbors at step 66, also considering mobility limit and neighbor signal strength. This may be referred to as Case 3.

FIG. 3B is another flow chart showing operation of the ECI locator module 24 to locate neighboring sectors and carriers. FIG. 3B illustrates operation for an IOS device, but similar operating systems to IOS may use the same implementation as well. FIG. 3B illustrates how the ECI locator module 24 identifies a most probable carrier and sector where an IOS user device 18 can get latched and returns the network capacity for the corresponding carrier and sector. The ECI locator module 24 considers the location of the user device 18 within the cell (whether it is near a cell tower, mid-cell, or on a cell edge), whether the user device 18 is co-located with multiple sector and carriers of neighboring overlapping cells, and whether the user device 18 is located in a region without known coverage.

The module starts at step 68, querying whether the user device 18 is located in the middle of a cell. If yes, then the module 24 proceeds to step 70, querying whether conservative mode is on. If yes, the module 24 returns collocated sector-carriers for carrier IDs 2, 3, and 4 at step 72. If no, the module 24 returns the sector-carrier with the highest download frequency at step 74. This may be referred to as Case 1.

Returning back to step 68, if the answer is no, then the module 24 queries whether the user device 18 has a location overlapped by multiple cells at step 76. If yes, then the module 24 proceeds to step 78, querying whether conservation mode is on. If yes, the module 24 returns all sector-carriers that provide coverage at step 80. If no, the module 24 returns the sector-carrier with the highest number of reports at step 82. This may be referred to as Case 2.

Returning back to step 76, if the answer is no, then the module 24 presumes a location without known coverage and queries whether conservative mode is on at step 84. If yes, then the module 24 returns co-located sector-carriers for carrier IDs 2, 3, and 4 which are closest to the user device 18 at step 86. If no, then the module 24 returns the sector-carrier which is closest to the user device 18 with the highest download frequency at step 88. This may be referred to as Case 3.

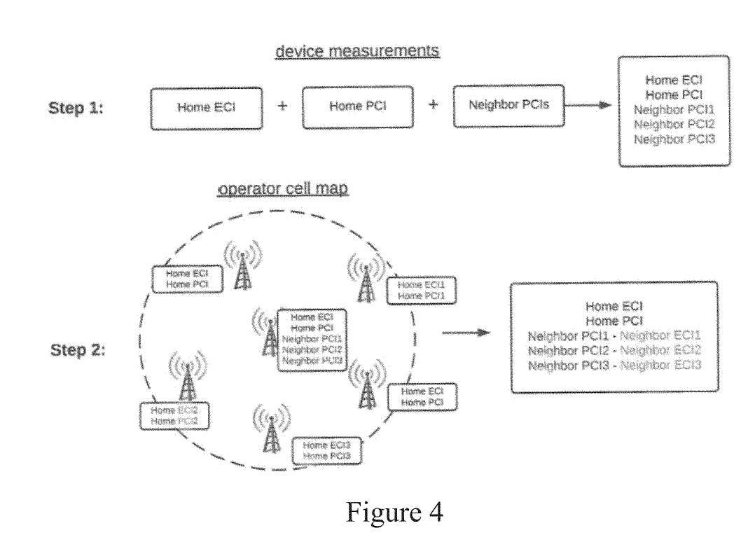

FIG. 4 is a diagram showing that the ECI locator module 24 may be configured update and auto-correct neighbor lists based on the frequency of radio data reported from user devices. The ECI locator module 24 is equipped to dynamically handle any change in cell triangulation parameters, radius, and/or azimuth information as well installation and/or removal of a unique ECI (EnodeB, sector, and/or carrier) and accordingly change the user device's coverage map. The ECI locator module 24 strikes a balance between mobility and capacity usage efficiency by allowing suitable configuration option for neighbor's radius and maximum number of allowable neighbors in case a device lies outside a coverage area. The ECI locator module 24 is capable of updating and auto-correcting neighbor list by removing old stale neighbors or adding a fresh new neighbor to its list based on frequency of radio data reported from user devices, updated cell map data received from the operator, and/or the user device's location within a sector, between overlapping sectors, or outside a coverage region.

FIG. 5A is a block diagram of new cell detection and old cell removal by incoming network data. During installation of a new cell tower, new cells are identified and old cells are removed. Antennae and other cell properties are also updated. Network capacity prediction services are activated for the new cell, as well as services related to session availability and record of analytics are enabled. A cell map processing module 90 detects new cells and/or removes old cells, which is then updated in an ECI database 92.

FIG. 5B is a block diagram of a cellular algorithm to update each cell's capacity prediction timeline. The prediction timeline is updated at different times of the day. Historic predictions are invoked to predict capacity in the present or future and prediction states are stored in a database for future reference. This illustrates the network receiver and aggregator module described earlier.

FIG. 5C is a block diagram of a receiving session request to compute session availability in the most probable ECI. A session availability module 94, along with the ECI locator module 24, discovers neighboring ECIs and PCIs (physical cell identities), estimates the most probable ECIs, and evaluates the most probable ECI's capacity among a set of dense or sparse ECIs for a normal or busy cell.

FIG. 5D is a block diagram of online cell classification and training along with built-in feedback techniques to incorporate error for prediction improvement. A characteristic cell's level of activity is derived and classified by setting a corresponding busy level. Online training and prediction may be invoked and a feedback loop may be introduced for error improvements.

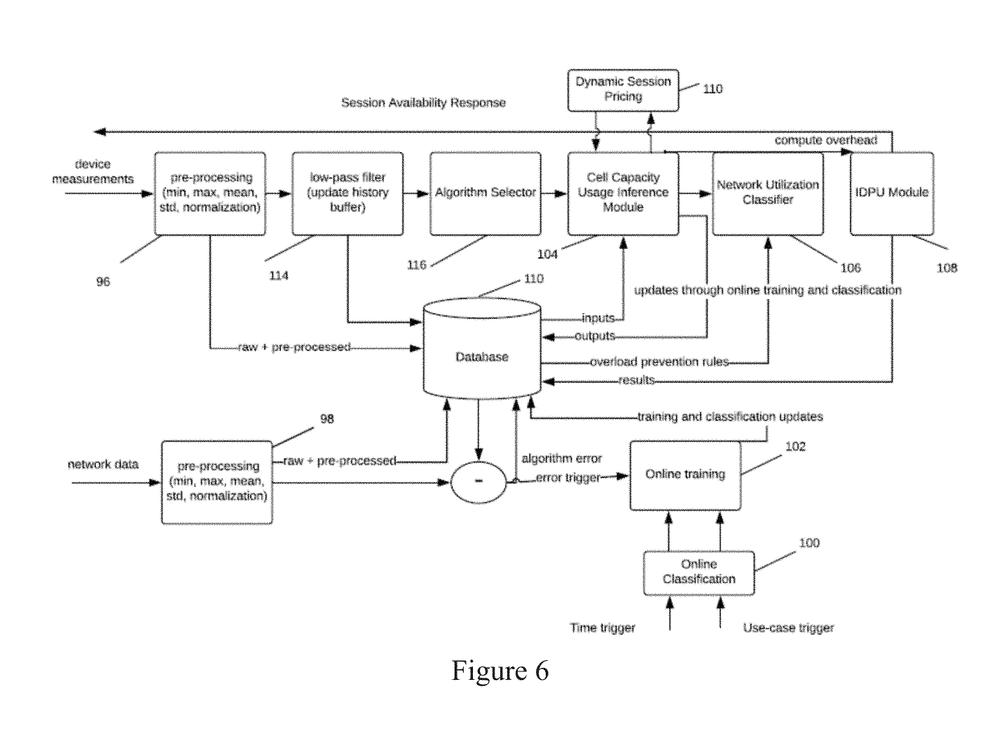

FIG. 6 is a block diagram further detailing the network capacity estimator module 30. The network capacity estimator module 30 has a first pre-processing unit 96 to select a few cells for user device RAN information from a varied group of cells. Such selection criteria include but is not limited to cells having min, max, mean, standard deviation, and/or normalization of radio information from several reporting made by a varied set of devices. The network capacity estimator module 30 has a second pre-processing unit 98 to select a few cells for device network information from a varied group of cells. Such selection criteria include but is not limited to cells with min, max, mean, standard deviation, and/or normalization of downlink throughput and downlink resource block utilization.

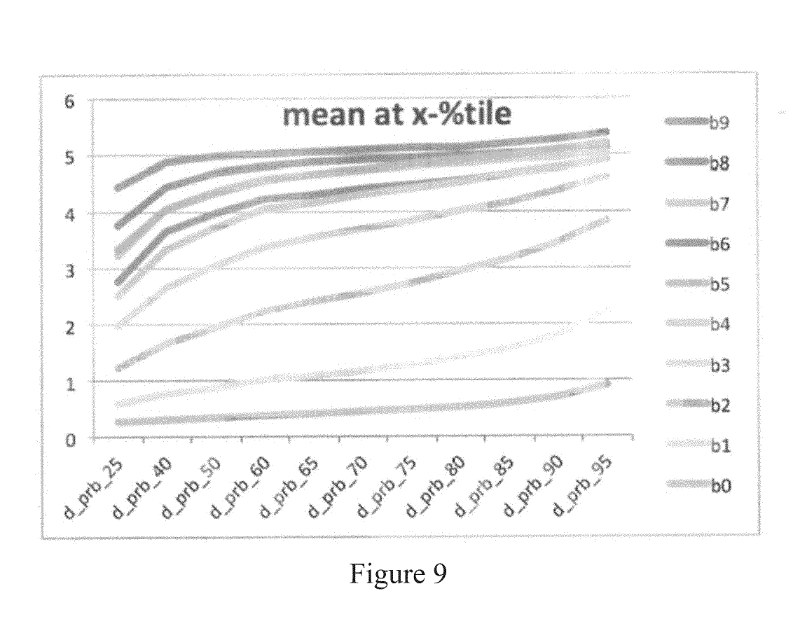

The network capacity estimator module 30 is equipped with an online classification module 100 to classify all available cells based on RAN and network information (e.g. bandwidth, throughput, band class, sector, carrier) filtered via the pre-processed units 96 and 98 hourly, weekly, bi-weekly, and/or monthly based on defined configuration values, change in cell behavior, or error reported from the analytics module 34. The network capacity estimator module 30 is further equipped with an online training module 102 to train classified cells from the online classification module 100 on their respective characteristics (cellular network characteristics including but not limited to busy level, throughput, reported RAN data, resource block utilization, and/or incremental capacity usage per megabytes per second (mbps) due to granting available network sessions). FIG. 9 shows a direct co-relation between higher incremental usage (IDPU) and busier cellular groups, having higher resolution block utilization and a higher number of users. The training process is auto-triggered on availability of new network data from an operator, change in cell class behavior, or error reported from the analytics module 34.

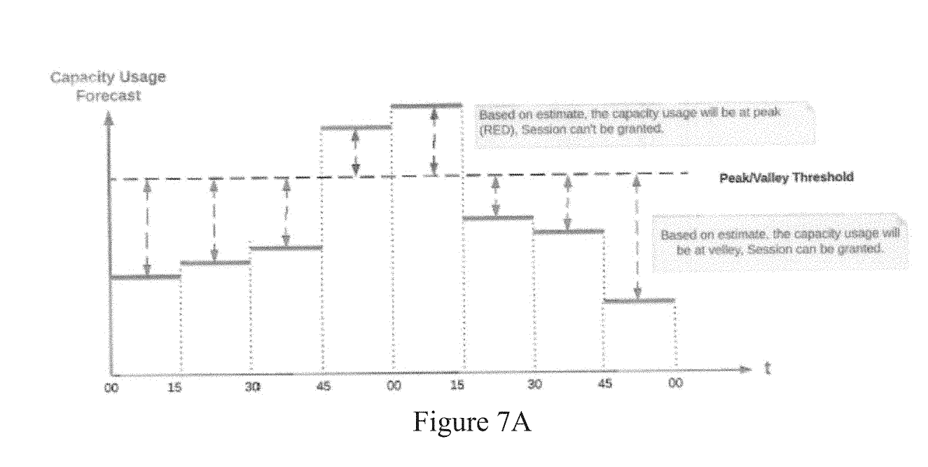

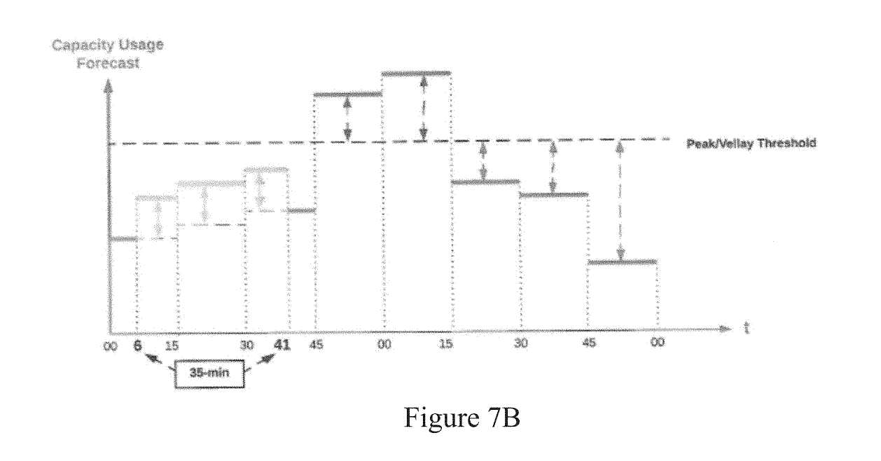

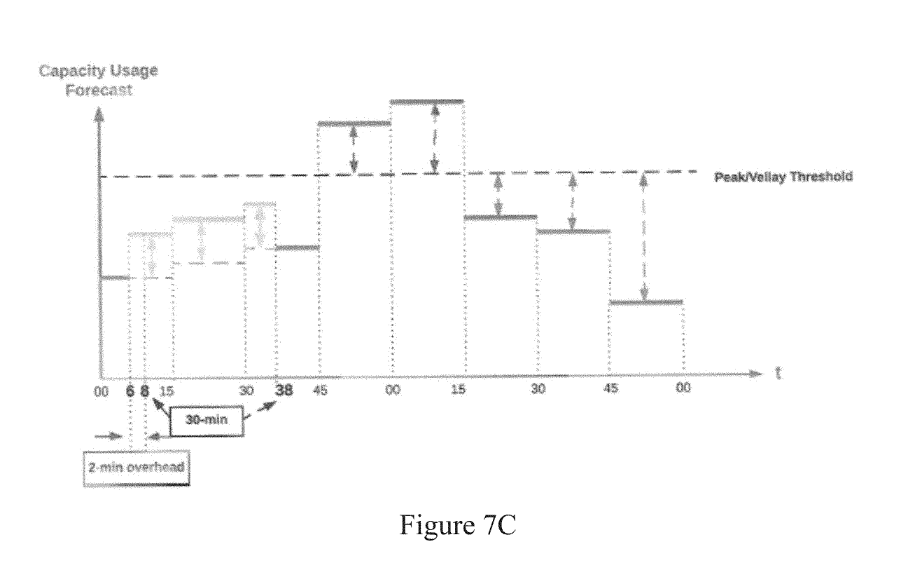

The network capacity estimator module 30 is also equipped with a cell capacity usage inference module 104 to predict the capacity usage and number of users in the cells in the present as well as in the nearest future (e.g., now, next 15 mins, 32 mins, 45 mins, 1 hour, 26 hours). This is graphically illustrated in FIGS. 7A, 7B, and 7C. FIGS. 7A-7C show a real time capacity calculation based on classification thresholds and dynamic readjustment of the thresholds based on cell type classification. Sessions will be granted at capacity usage valleys and not granted at capacity usage peaks. Further, the cell capacity usage inference module 104 is capable of attaching suitable weights to past historic network and radio data (e.g. t-1h, t-2h, t-1d, t-1-week, t-2-weeks) to increase accuracy in its prediction level.

Referring back to FIG. 6, the network capacity estimator module 30 is equipped with a network utilization classifier module 106 containing capacity availability decision thresholds of different classified cell groups. The threshold criteria serve as final decision maker criteria for granting available sessions to any application when capacity remains available during the entire grant duration of the session. This is also graphically illustrated in FIGS. 7A-7C.

The network capacity estimator module further includes a session overhead/penalty module called an IDPU unit 108 that takes into consideration overhead introduced by data usage by sessions granted in different classified cell groups to different applications. The IDPU unit 108 estimates incremental load in any cell, calculated by considering IDPU to achieve 5 Mbps download speed throughput. Other download speeds can be considered as well in alternative embodiments. FIG. 9 shows the co-relation between different classified cellular groups and IDPU. IDPU has a relationship with cell signal strength, which increases or decreases based on distance of the device from a cell-tower, with highest signal strength when near a cell-tower. Further, IDPU is configured to be calculated for different cellular groups based on busy/non-busy hours and/or weekdays/weekend.

The network capacity estimator module 30 is equipped with a database/cache 110 to store all available cells' network classification thresholds as well as predicted values of cell capacity.

The network capacity estimator module 30 is further equipped with a dynamic pricing module 112 to decide the cost of each granted session depending on cell type, historic trends, capacity available, and/or maximum number of sessions to be granted among neighboring ECIs.

The network capacity estimator module 30 additionally includes a low pass filter 114, which selects device measurements (e.g. signal strength, SNR) based on accepted ranges for varying device operating systems, makes, and model. An algorithm selector module 116 is also included to select the specific algorithm based on signal strength information, location of device, and cell type as reported by the user device 18.

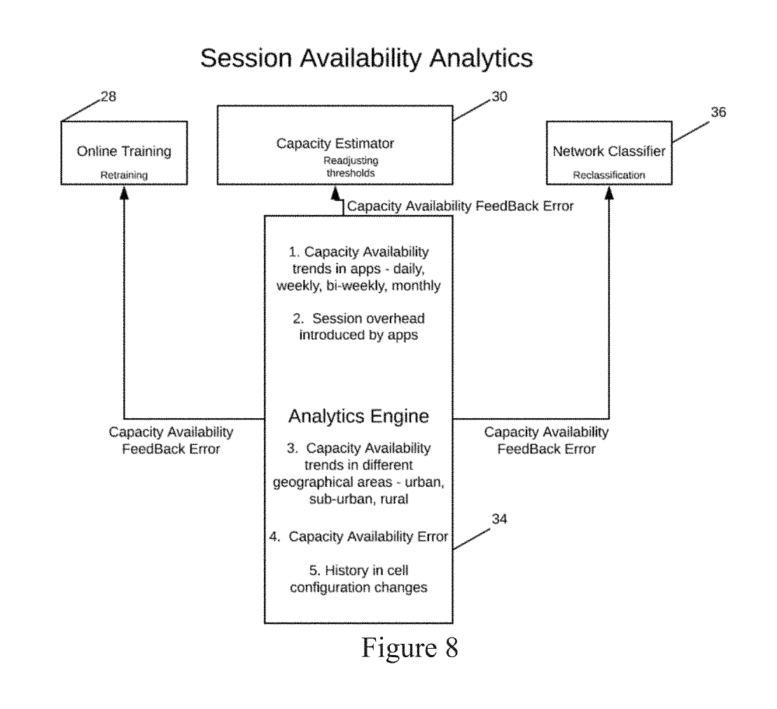

FIG. 8 is a diagram further detailing the analytics module 34. The analytics module 34 may more specifically be referred to as an analytics, error reporting, and feedback engine. The analytics engine 34 can analyze predicted network outcomes against true network availability and provide feedback to the online classification module 26 and training module 28 to auto-correct errors. The analytics engine 34 analyses available network sessions granted as well as additional network overhead introduced due to session grants by different kinds of applications. The penalty/overhead for each device and its location from cell-tower and cell-type is then provided as a feedback for auto-correction of overhead values associated with different cellular groups.

The analytics engine 34 is capable of estimating daily, weekly, bi-weekly, and/or monthly network capacity and grants in different cellular classification groups and providing input to the network capacity estimator module 30 to dynamically adjust thresholds to benchmark. For instance, this can include conditions for allowing excess network session to a 3rd party application for a classified cell group and/or conditions for allowing a maximum number of additional sessions to a 3rd party application for a classified cell group. The analytics engine 34 records historic changes in individual cell properties and hence changes in cellular coverages.

Embodiments of the above disclosed invention allow for inferencing cell load from user device location from certain mobile devices which does not provide any application programming interface (API) to infer cell load. It also allows for effective usage of under-utilized network capacity at non-busy times of the day in any cellular operator network. Embodiments of the disclosed invention can be easily integrated via an auto-discovery mechanism enabled through an application or software development kit (SDK) to discover under-utilized capacity at the current ECI.

Embodiments of the disclosed invention prevent over-utilization during network session grants by controlling the number of sessions granted per cell depending on the type of application to which sessions are granted. Deployment in an operator network is scalable to handle online classification and training for over 1 million cells as well as serving requests in real-time. Auto-reclassification and tuning mechanisms can redefine and bench-mark behavioral patterns for each cell category.

Embodiments of the disclosed invention allow for a mechanism to detect quick change events like cell overload in historically under-utilized cells, (e.g., a remotely located stadium cell), adapt the network capacity for short duration, and quickly re-learn and re-adapt once the event is over. Embodiments of the disclosed invention also allow for estimating incremental cell capacity based on device location from cell-tower, when device is located near cell-tower, mid-cell, or at the cell-edge.

Embodiments of the disclosed invention can infer incremental capacity effect on different cell types while granting network sessions to different kinds of applications. Embodiments of the disclosed invention allow for an auto-learning capability to learn information on new cells installed or removed from the cellular operator network. Embodiments of the disclosed invention allow for a suitable platform for cellular operators and content partners to offer promotions, discounts and rewards through apps during under-utilized network periods.

Embodiments of the disclosed system enable easy integration to diverse mobile platforms across multiple operator networks to utilize under-utilized network efficiently. The system, in addition to learning and inferring RF data for mobile devices, provides in-built intelligence to learn cell type and cell load from a rectangular grid system through collected crowdsourced data. The system is scalable and easily deployable in any operator network with infrastructure for real time computation. The approach for determining online cellular capacity and predicting its capacity change aids operators in correctly laying out cellular network designs and plans. In addition, the network capacity prediction algorithm provides operators a budget friendly mechanism for network provisioning. The system further provides a framework to operators and content partners to address app monetization in any kind of cellular network (e.g. 3G, 4G, 5G, femto cell, ZigBee).

It is understood that the above-described embodiments are only illustrative of the application of the principles of the present invention. The present invention may be embodied in other specific forms without departing from its spirit or essential characteristics. All changes that come within the meaning and range of equivalency of the claims are to be embraced within their scope. Thus, while the present invention has been fully described above with particularity and detail in connection with what is presently deemed to be the most practical and preferred embodiment of the invention, it will be apparent to those of ordinary skill in the art that numerous modifications may be made without departing from the principles and concepts of the invention as set forth in the claims.

What is claimed is:

1. A system for granting available network capacity to one or more mobile devices in a cellular operator network, the system comprising:
an EUTRAN cell identifier (ECI) locator module configured to determine the ECI the mobile device is connected to at a given location;
an online classification module configured to classify one or more cells within cellular networks;
a network capacity estimator module configured to estimate individual cell capacity for the cellular operator network, predict available network capacity, and estimate an impact of granted sessions for any ECI to which the mobile device is connected;
a network capacity grant module configured to grant available network capacity based on the predicted available network capacity and estimated impact of granted sessions; and
an analytics module configured to analyze predicted network capacity compared to actual network availability and provide feedback to the online classification module and network capacity estimator module.

2. The system of claim 1 wherein the ECI determines a cell coverage radius and a home sector based on a current location of the mobile device, device radio data, cell tower configuration, and radio frequency propagation models out of all sectors covering the location of the mobile device.

3. The system of claim 1 wherein the ECI locator module is further configured to split a geographical region covered by the cellular operator network into a grid and sub-divide the geographical region further into smaller grids to determine the cell coverage radius of the mobile device.

4. The system of claim 1 wherein the ECI locator module is further configured to receive crowdsourced radio access network (RAN) information from available neighboring mobile devices, the crowdsourced RAN information being modelled dynamically using probabilistic weighted modelling to derive a current home sector of the mobile device.

5. The system of claim 4 wherein the crowdsourced RAN information model is configured to infer a type of cell, band, and carrier.

6. The system of claim 5 wherein the crowdsourced RAN information model takes into consideration a band preference in ascending order while returning a most probable sector where the mobile device is located.

7. The system of claim 1 wherein the ECI locator module is further configured to update and auto-correct a neighbor list based on frequency of radio data reported from neighboring mobile devices, updated cell map data received from the network operator, and a location of the mobile device.

8. The system of claim 1 wherein the online classification module is further configured to extract cells from different localities and compute statistics of cell characteristics and behavior for a given locality based on current and historical data.

9. The system of claim 1 wherein the online classification module is further configured to classify cellular networks based on location, bandwidth, sector, carrier, and antennae direction.

10. The system of claim 1 further comprising an online training module configured to train the online classification module and network capacity estimator module based on the feedback received from the analytics module.

11. The system of claim 1 wherein the network capacity estimator module is further configured to use classification data from the online classification module to estimate individual cell capacity for the operator network at current and different future time instants.

12. The system of claim 1 wherein the network capacity estimator module is further configured to determine a number of network sessions that can be granted to a mobile device in an ECI.

13. The system of claim 1 wherein the network capacity estimator module is further configured to determine a change in network throughput after a network session is granted.

14. The system of claim 1 wherein the network capacity estimator module is further configured to learn incremental data physical-resource utilization (IDPU) for a category of cells.

15. A method for granting available network capacity to one or more mobile devices in a cellular operator network, the method comprising:
determining an ECI the mobile device is connected to at a given location;
classifying one or more cells within cellular networks;
estimating individual cell capacity for the cellular operator network and predicting available network capacity for the ECI to which the mobile device is connected;
granting available network capacity based on the predicted available network capacity; and
analyzing predicted network capacity compared to actual network availability and providing feedback.

16. The method of claim 15 further comprising splitting a geographical region covered by the cellular operator network into a grid and sub-dividing the geographical region further into smaller grids to determine the cell coverage radius of the mobile device.

17. The method of claim 15 further comprising receiving crowdsourced radio access network (RAN) information from available neighboring mobile devices, the crowdsourced RAN information being modelled dynamically using probabilistic weighted modelling to derive a current home sector of the mobile device.

18. The method of claim 17, wherein the crowdsourced RAN information is able to identify changes in a cell's capacity due to increases or decreases in upload or download data volumes.

19. The method of claim 15 further comprising classifying cellular networks based on location, bandwidth, sector, carrier, and antennae direction.

20. The method of claim 15 further comprising using classification data to estimate individual cell capacity for the operator network at current and different future time instants.

21. The method of claim 15 further comprising determining a number of network sessions that can be granted to a mobile device in an ECI.

22. The method of claim 15 further comprising determining a change in network throughput after a network session is granted.

23. The method of claim 15 further comprising learning incremental data physical-resource utilization (IDPU) for a category of cells.
